(19) United States
(12) Patent Application Publication
(10) Pub. No.: US 2015/0041127 A1
(43) Pub. Date: Feb. 12, 2015

(54) OIL/WATER SEPARATION METHOD, OIL-CONTAINING WATER TREATMENT METHOD, BITUMEN PRODUCTION METHOD AND SYSTEM THEREFOR

(71) Applicant: NITTO DENKO CORPORATION, Ibaraki-shi, Osaka (JP)

(72) Inventors: Nobuharu Kuki, Ibaraki-shi (JP); Ryoichi Matsushima, Ibaraki-shi (JP)

(21) Appl. No.: 14/384,057

(22) PCT Filed: Feb. 22, 2013
(86) PCT No.: PCT/JP2013/054486

§ 371 Date: Sep. 9, 2014

(30) Foreign Application Priority Data
Mar. 9, 2012 (JP) 2012-053260

(51) Int. Cl. B01D 61/36; B01D 71/36; E21B 43/24; B01D 63/08; E21B 43/34; B01D 69/02; B01D 63/06

(52) U.S. Cl. CPC B01D 61/364; B01D 69/02; B01D 71/36; B01D 63/06; B01D 63/08; E21B 43/34; E21B 43/2406; B01D 2311/106; B01D 2311/25; B01D 2325/36; B01D 2319/04; B01D 2319/02; B01D 2325/02
USPC 166/266; 210/640; 210/321.6; 210/321.84; 210/321.87; 166/52

(57) ABSTRACT

Provided is an oil/water separation method that is capable of decreasing the frequency of clogging. The method is for separating oil and water from each other that are generated by an in-situ recovery method for producing bitumen 82 from oil sand (1500). After oil-containing water (83, 84) obtained as a result of the bitumen 82 being removed from a bitumen-mixed fluid 81 recovered from under the ground is prepared, the step of membrane-distilling the oil-containing water 84 by use of a distillation membrane member 10 formed of a porous membrane 20 is performed.

The present invention relates to an oil/water separation method, an oil-containing water treatment method, a bitumen production method and a system therefor; and specifically to oil/water separation performed as a part of a method for producing bitumen from oil sand.

The present application claims the benefit of priority based upon Japanese Patent Application No. 2012-53260 filed on Mar. 9, 2012, the entirety of which is incorporated herein by reference.

### BACKGROUND ART

Bitumen is recovered from oil sand, which is one of petroleum resources, and has been considered merely as a preliminary or next-generation alternative resource so far. Bitumen itself may be of poor quality, but products obtained therefrom are sufficiently competitive as compared with products obtained from crude oil. Also in terms of costs, the possibility that bitumen replaces crude oil has been increasing (see, for example, Patent Document 1).

Canada has a huge reserve of oil sand that is comparable to that of crude oil in Saudi Arabia. For example, the reserve of hydrocarbon in Province of Alberta and the surrounding areas in Canada is one of the largest in the world. Canada has an advantage, among others, that the risk of investment is small unlike such geopolitically unstable countries as those in Middle East and Africa. Securing a stable energy supply source is highly important for Japan and other countries poor in natural resources. From this point of view, Canada is now considered as an important petroleum resource supply region.

Recently, regarding bitumen production from oil sand, attention has been paid to oil sand that is present at a depth at which it is difficult to mine oil sand by open-pit mining. For mining oil sand at such a depth, in-situ recovery methods such as an SAGD (Steam Assisted Gravity Drainage) method, a CSS (Cyclic Steam Stimulation) method and the like now attract attention, and technologies concerning these methods are being actively developed.

According to such an in-situ recovery method, high temperature steam is injected into highly viscous oil that is present in an oil sand layer and does not flow at room temperature. As a result, the oil is heated to decrease the viscosity thereof. The steam recovers the agglomerated high temperature water and oil. In order to realize this, “water” for generating a huge amount of high temperature steam is required. For example, the SAGD method uses water about three times the production amount of oil in order to generate steam. However, in Canada, the amount of water intake is restricted by the strict environmental standards of the Province, and in the vicinity of the oil sand, there is no layer into which a sufficient amount of discharged water can be injected. Therefore, water recycling is indispensable.

### CITATION LIST

### Patent Document

Patent Document 1: Japanese Patent Laid-Open Publication No. 2010-248431

### SUMMARY OF THE INVENTION

### Technical Problem

According to the conventional SAGD or CSS method, a bitumen-mixed fluid recovered from under the ground (oil sand layer) by an in-situ recovery method is treated by a separator to remove bitumen. Then, oil-containing water separated from the bitumen (also referred to as “produced water”) is cooled to a predetermined temperature and then transferred through a plurality of predetermined tanks to have an oil component separated therefrom. Then, the treated water is recovered. The oil/water separation performed by this method is basically gravitational separation that uses the specific gravity difference between oil and water. The treated water is recovered in this manner, and thus the water used for generating bitumen is recycled.

However, this oil/water separation method has problems that oil/water separation requires many devices and steps and thus is complicated, that the facilities are costly, and that it is difficult to manage the operation of the facilities. In addition, the gravitational separation method can remove an oil component having a relatively large particle diameter but has a problem of not separating an oil component having a small particle diameter or an emulsified oil component. If the oil component is not separated, organic scale is deposited in pipes in a heat exchanger or a boiler, and as a result, corrosion fracture may be caused by a thermal stress. In addition, in the case where an evaporator is used in a desalination step, scale trouble occurs by organic substances in the evaporator, which may cause a problem.

Patent Document 1 describes that in the case where a ceramic precision filtration membrane or ultrafiltration membrane is used, the installation area is increased because a ceramic membrane generally has a large capacity per membrane area and is heavy. In addition, a ceramic membrane is weak against a mechanical or thermal impact. Regarding a ceramic membrane, there is also the following disadvantage. A binder generally used for generating a ceramic membrane is not alkali-resistant, and the ceramic membrane cannot be washed with a strong alkaline aqueous solution when a plane of the membrane is clogged. Furthermore, there is a practical problem that a ceramic membrane is costly.

Patent Document 1 discloses the following oil/water separation method that is used as a part of an in-situ recovery method of generating bitumen from oil sand. From a warmed bitumen-mixed fluid recovered from under the ground, bitumen is removed. Warmed oil-containing water separated from the bitumen-mixed fluid is treated with a precision filtration membrane formed of polytetrafluoroethylene. Patent Document 1 describes that according to the oil/water separation method disclosed therein, the complicated multi-stage steps or special facilities as conventionally needed are not required, the facilities are easy to handle, the operation thereof is easily managed, the warmed oil-containing water can be separated into oil and water at a high level, and thermal loss can be reduced.

However, studies made by the present inventor found the following problems of the oil/water separation method disclosed in Patent Document 1. First, with the oil/water separation method disclosed in Patent Document 1 using a filtration membrane, the membrane is contaminated and thus clogged with oil entering the inside thereof, which decreases the flow rate of transmission through the membrane. In addition, the contaminants resulting from the filtration are deposited on the surface of the membrane, which also decreases the flow rate of transmission through the membrane.

The filtration membrane formed of polytetrafluoroethylene (PTFE) has the following problem. PTFE is hydrophobic and therefore needs to be treated to be hydrophilic in order to allow water to pass the filtration membrane smoothly. As a method for such treatment, the following method is conceivable. The PTFE membrane is impregnated with an aqueous solution of polyvinyl alcohol so that microscopic holes of the membrane are filled with the aqueous solution of polyvinyl alcohol, and an acidic catalyst is used to crosslink polyvinyl alcohol with dialdehyde. However, the PTFE membrane treated to be hydrophilic is deteriorated in hydrophillicity by the heat in use and is made hydrophobic again. As a result, the PTFE membrane does not pass the water sufficiently well.

In such a situation, the present inventor made active studies to develop a novel oil/water separation method (oil-containing water treatment method) instead of improving the oil/water separation method (oil-containing water treatment method) using a filtration membrane, and reached the present invention.

The present invention made in light of the above-described points has a main object of providing an oil/water separation method capable of decreasing the frequency of clogging as compared with an oil/water separation method using a filtration membrane, an oil-containing water treatment method, a bitumen production method, and a system therefor.

### Solution to the Problem

An oil/water separation method according to the present invention is for separating oil and water from each other that are generated by an in-situ recovery method for producing bitumen from oil sand. The oil/water separation method includes the steps of preparing oil-containing water obtained as a result of the bitumen being removed from a bitumen-mixed fluid recovered from under the ground; and membrane-distilling the oil-containing water by use of a distillation membrane member formed of a porous membrane.

In a preferable embodiment, the distillation membrane member is formed of porous polytetrafluoroethylene.

In a preferable embodiment, the distillation membrane member is formed of a hydrophobic material.

In a preferable embodiment, the distillation membrane member is formed of a porous membrane that is not treated to be hydrophilic.

In a preferable embodiment, the distillation membrane member is formed of a porous membrane that is treated to be liquid-repellent.

In a preferable embodiment, the distillation membrane member is formed of a porous membrane having an average hole diameter of 0.01 μm or greater and 10 μm or less.

In a preferable embodiment, the oil-containing water to be membrane-distilled has a temperature of 50° C. or higher.

In a preferable embodiment, the step of membrane-distilling includes the step of cooling steam that is vaporized as a result of the oil-containing water passing the porous membrane and thus making the steam a liquid.

In a preferable embodiment, in the step of membrane-distilling, the oil-containing water is again circulated and supplied to be membrane-distilled after contacting the distillation membrane member.

In a preferable embodiment, a plurality of the distillation membrane members are provided; and the oil-containing water is distilled in a multi-stage manner by the plurality of distillation membrane members.

In a preferable embodiment, at least two of the plurality of distillation membrane members are located parallel to each other; and the oil/water separation method further comprises the step of replacing one of the distillation membrane members located parallel to each other.

In a preferable embodiment, treated water obtained as a result of the membrane distillation has an oil concentration of 10 mg/liter or less.

In a preferable embodiment, the in-situ recovery method is an SAGD method or a CSS method.

An oil-containing water treatment method according to the present invention is for treating oil-containing water containing an oil component and water. The oil-containing water treatment method includes the step of membrane-distilling the oil-containing water containing the oil component and water by use of a distillation membrane member formed of a porous membrane.

In a preferable embodiment, the distillation membrane member is formed of a porous membrane that is not treated to be hydrophilic; and in the step of membrane-distilling the oil-containing water, the oil-containing water is again circulated and supplied to be membrane-distilled after contacting the distillation membrane member.

In a preferable embodiment, the distillation membrane member is formed of porous polytetrafluoroethylene.

A bitumen production method according to the present invention is for producing bitumen from oil sand. The bitumen production method includes the steps of introducing steam into an oil sand layer containing oil sand; recovering a bitumen-mixed fluid containing the bitumen from the oil sand layer by the steam; separating the bitumen from the bitumen-mixed fluid; and membrane-distilling oil-containing water, obtained as a result of the bitumen being separated from the bitumen-mixed fluid, by use of a distillation membrane member formed of a porous membrane.

In a preferable embodiment, the bitumen production method further includes the step of introducing water generated by the membrane distillation into the oil sand layer.

In a preferable embodiment, the distillation membrane member is formed of porous polytetrafluoroethylene.

An oil/water separation system according to the present invention is for separating oil and water from each other that are generated by an in-situ recovery method for producing bitumen from oil sand. The oil/water separation system includes a membrane distillation device for membrane-distilling oil-containing water obtained as a result of the bitumen being removed from a bitumen-mixed fluid recovered from under the ground. The membrane distillation device includes a distillation membrane member formed of a porous membrane.

In a preferable embodiment, the membrane distillation device includes the distillation membrane member; an oil-containing water storage site which is in contact with a surface of the porous membrane that forms the distillation membrane member and to which the oil-containing water is supplied; and a steam discharge site from which steam of water contained in the oil-containing water is discharged as a result of the oil-containing water from the oil-containing water storage site passing the porous membrane. The steam discharge site is connected to a pressure reduction pipe.

In a preferable embodiment, the oil-containing water flows in the oil-containing water storage site; and the membrane distillation device is connected to a pipe through which the oil-containing water is circulated.

In a preferable embodiment, the distillation membrane member is located in a planar state in the membrane distillation device.

In a preferable embodiment, the membrane distillation device has a cylindrical shape; and the distillation membrane member is located in a cylindrical shape in the membrane distillation device.

In a preferable embodiment, the distillation membrane member is formed of porous polytetrafluoroethylene.

In a preferable embodiment, a plurality of the distillation membrane members are provided; at least two of the plurality of distillation membrane members are located parallel to each other; and one of the plurality of distillation membrane members located parallel to each other is replaceable while membrane distillation is performed by another of the plurality of distillation membrane members located parallel to each other.

An oil-containing water treatment system according to the present invention is for treating oil-containing water containing an oil component and water. The system includes a membrane distillation device for membrane-distilling the oil-containing water. The membrane distillation device includes a distillation membrane member formed of a porous membrane.

A bitumen production system according to the present invention is for producing bitumen from oil sand. The system includes an introduction pipe through which steam is introduced into an oil sand layer containing the oil sand; a recovery pipe through which a bitumen-mixed fluid containing the bitumen is recovered from the oil sand layer by the steam; a separation device that is connected to the recovery pipe and separates the bitumen from the bitumen-mixed fluid; and a membrane distillation device for membrane-distilling oil-containing water, obtained as a result of the bitumen being separated from the bitumen-mixed fluid, by use of a distillation membrane member formed of a porous membrane.

### Advantageous Effects of Invention

According to an oil/water separation method of the present invention, oil-containing water obtained as a result of bitumen being removed from a bitumen-mixed fluid recovered from under the ground is membrane-distilled by use of a distillation membrane member formed of a porous membrane. Therefore, the frequency of clogging can be decreased as compared with an oil/water separation method using filtration membrane. Such an oil/water separation method of the present invention also solves the problems of a gravitational separation method using the specific gravity difference between oil and water, namely, the problems that the oil/water separation requires many devices and steps and thus is complicated, the facilities are costly, and it is difficult to manage the operation of the facilities.

### BRIEF DESCRIPTION OF THE DRAWINGS

FIG. 1 shows an SAGD method of removing bitumen from an oil sand layer 1500 under the ground 1000.

FIG. 2 is a cross-sectional view of FIG. 1, which shows how water steam 1150 expands.

FIG. 3 schematically shows a structure of oil sand 2000.

FIG. 4 shows a bitumen production plant 3000.

FIG. 5 shows a bitumen production system 200 including an oil/water separation system 100 according to an embodiment of the present invention.

FIG. 6 is a cross-sectional view schematically showing a structure of an example of the membrane distillation device 100 according to an embodiment of the present invention.

FIG. 7 schematically shows a structure of a porous membrane 20.

FIG. 8 is a structural view of a membrane distillation device 110 used for an experiment performed on examples of the present invention.

FIG. 9 is a perspective view showing an example of the membrane distillation device 100 according to an embodiment of the present invention.

FIG. 10 is a schematic view showing an example of pipework of the membrane distillation device 100 according to an embodiment of the present invention.

FIG. 11 schematically shows a structure of a condensation unit 70 according to an embodiment of the present invention.

FIG. 12 schematically shows a structure of a condensation unit 90 that includes a water-sealed pump 95.

FIG. 13 is a schematic view showing an example of pipework of the membrane distillation device 100 according to an embodiment of the present invention.

FIG. 14 is a schematic view showing an example of pipework of the membrane distillation device 100 according to an embodiment of the present invention.

### DESCRIPTION OF EMBODIMENTS

As described above, bitumen recovered from oil sand now attracts much attention as one of petroleum resources. Regarding bitumen production from oil sand, technology is now being developed on in-situ recovery methods for recovering oil sand in stratum at a depth at which it is difficult to mine oil sand by open-pit mining, by which oil sand in a surface layer is mined by use of a gigantic shovel. Such in-situ recovery methods include an SAGD method and a CSS method.

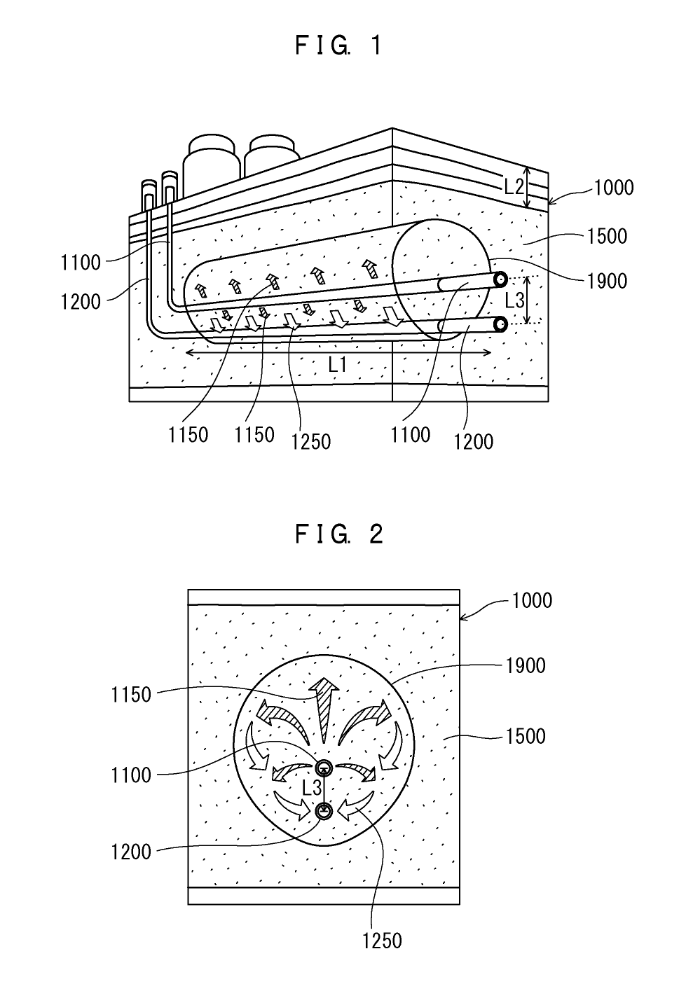

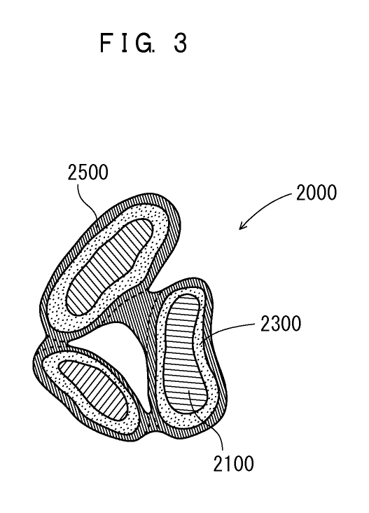

With reference to FIG. 1 through FIG. 3, the SAGD method will be briefly described. FIG. 1 shows an oil sand layer 1500 under the ground 1000. FIG. 2 is a cross-sectional view of FIG. 1. FIG. 3 is a schematic view of oil sand 2000.

As shown in FIG. 1 and FIG. 2, according to the SAGD method, a steam introduction pipe 1100 is provided. The steam introduction pipe 1100 acts as a water steam injection well that injects water steam into the oil sand layer 1500 containing oil sand under the ground 1000. Below the steam introduction pipe 1100, a recovery pipe 1200 is provided. The recovery pipe 1200 acts as a bitumen production well usable to recover a bitumen-mixed fluid 1250, which is melted by steam 1150 ejecting from the steam introduction pipe 1100.

The steam introduction pipe 1100 and the recovery pipe 1200 each extend by a length L1 (e.g., 500 to 1000 m). The oil sand layer 1500 is located at a depth of L2 (e.g., about 300 m or greater) below the surface of the ground. The distance between the steam introduction pipe 1100 and the recovery pipe 1200 is L3 (e.g., about 5 m).

FIG. 3 shows a structure of the oil sand 2000. The oil sand is considered to be generated as follows. Oil that is generated as a result of decomposition of deposited organic substances is exposed to the vicinity of the ground surface by crustal deformation, and is made heavy as a result of a light or medium hydrocarbon component thereof being volatilized and disappearing, or is made heavy as a result of biodegradation. The oil sand 2000 is semisolid crude oil that does not flow in an oil layer state, and is contained in an unconsolidated sandstone layer. The oil sand 2000 under the ground exists in a state where sand particles 2100 are surrounded by water 2300, which is surrounded by bitumen 2500. The bitumen 2500 is heavy and highly viscous hydrocarbon.

The SAGD method is performed as follows. High temperature water steam is injected through the steam introduction pipe 1100 into the highly viscous bitumen 2500, which is located in the oil sand layer 1500 under the ground and does not flow at room temperature. The fluidity of the bitumen 2500 in a predetermine area 1900 of the oil sand layer 1500 is increased by the water steam 1150 released from the steam introduction pipe 1100. Next, the bitumen 2500 having such an increased fluidity under the ground is recovered through the recovery pipe 1200 together with warm water 1250. The warm water (bitumen-mixed fluid) 1250, containing the bitumen 2500, also contains heavy metal, sand and the like.

According to the CCS method, the bitumen is recovered as follows. First, water steam is injected into a well for a certain time period, and then the injection of the water steam is stopped and the well is closed. Next, it is waited for a while for the heat of the water steam to be transmitted to the oil sand layer 1500 and for the bitumen 2500 to be fluidized. Then, the well is opened, and the bitumen-mixed fluid 1250 flowing into the well is pumped up.

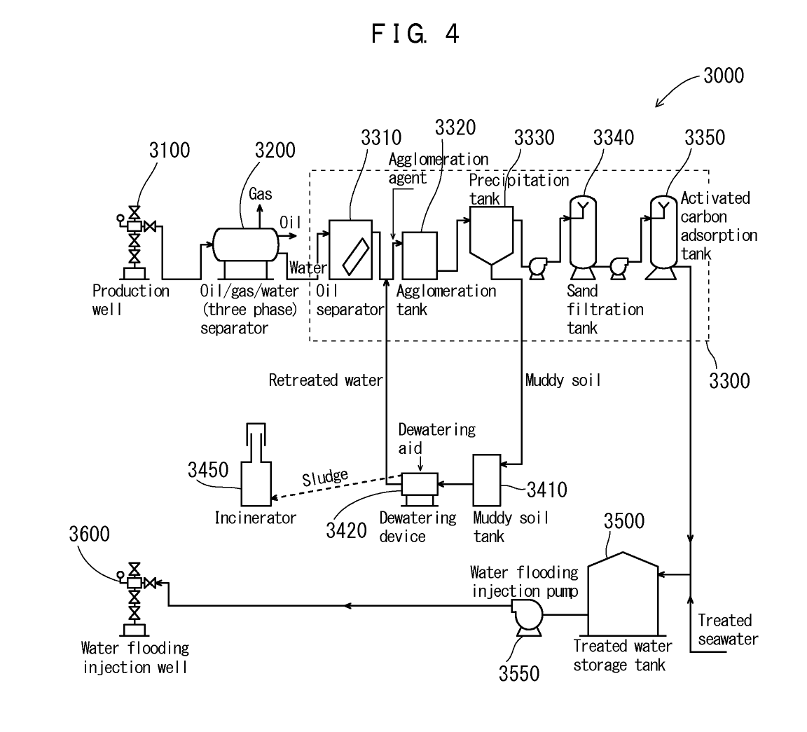

Next, the bitumen-mixed fluid 1250 is generally treated by a treatment device (bitumen production plant) 3000 as shown in FIG. 4. The bitumen-mixed fluid 1250 that is pumped up from a production well 3100 (recovery pipe 1200) is transferred to a separator 3200 and is separated into three phases of gas, oil and water. The water separated by the separator 3200 is oil-containing water that still contains oil. From the oil-containing water, oil, sand and the like are separated. Thus, recycled water is produced.

Specifically, the oil-containing water from the separator 3200 is transferred to an oil/water separation unit 3300 using a gravitational separation method. The oil/water separation unit 3300 includes an oil separator 3310, an agglomeration tank 3320, a precipitation tank 3330, a sand filtration tank 3340, and an activated carbon adsorption tank 3350. The oil-containing water is sequentially transferred to these elements to be treated. Before entering the agglomeration tank 3320, the oil-containing water is provided with an agglomeration agent. Muddy soil generated in the precipitation tank 3330 is transferred to a muddy soil tank 3410 and is dewatered by a dewatering device 3420 by use of a dewatering aid. Sludge generated in the dewatering device 3420 is incinerated by an incinerator 3450. Retreated water in the dewatering device 3420 is again introduced into the agglomeration tank 3320. Treated water in the activated carbon adsorption tank 3350 is transferred to a treated water storage tank 3500. In the case where seawater is used, treated seawater (in the case where the seawater is not used, treated plain water) is additionally put into the treated water storage tank 3500. The treated water in the treated water storage tank 3500 is transferred to a water flooding injection well 3600 (water steam injection well or steam introduction pipe 1100) by a water flooding injection pump 3550.

In the treatment device (bitumen production plant) 3000 shown in FIG. 4, water is recycled by the above-described treatment steps. The oil/water separation unit 3300 using the gravitational separation method performs treatment on the water mainly by gravitational separation. Therefore, an oil component having a relatively large particle diameter can be removed, but an oil component having a small particle diameter or an emulsified oil component cannot be separated. In addition, the oil/water separation requires many devices and steps and thus is complicated, the facilities are costly, and it is difficult to manage the operation of the facilities.

According to the technique disclosed in Patent Document 1, the warmed oil-containing water separated from the bitumen-mixed fluid is treated by a precision filtration membrane formed of polytetrafluoroethylene, and thus the above-described problems of complicated multi-stage steps and special facilities are alleviated. However, this technique has a problem that the membrane is contaminated and thus clogged with oil entering the inside of the membrane, which decreases the flow rate of transmission through the membrane. This technique also has a problem that the contaminants resulting from the filtration are deposited on the surface of the membrane, which also decreases the flow rate of transmission through the membrane.

In such a situation, the present inventors, in an attempt to develop a new technique that is not a gravitational separation method or a filtration method, conceived a method of producing recycled water from oil-containing water, separated from the bitumen-mixed fluid, by oil/water separation using membrane distillation, and thus reached the present invention. Hereinafter, preferable embodiments of the present invention will be described with reference to the drawings. Elements which are other than elements specifically referred to in this specification and are necessary to carry out the present invention may be grasped as a matter of design choice for a person of ordinary skill in the art based on the conventional technology in this field. The present invention can be carried out based on the contents disclosed by this specification and the attached drawings, and the technological common knowledge in the art. The present invention is not limited to the following embodiments.

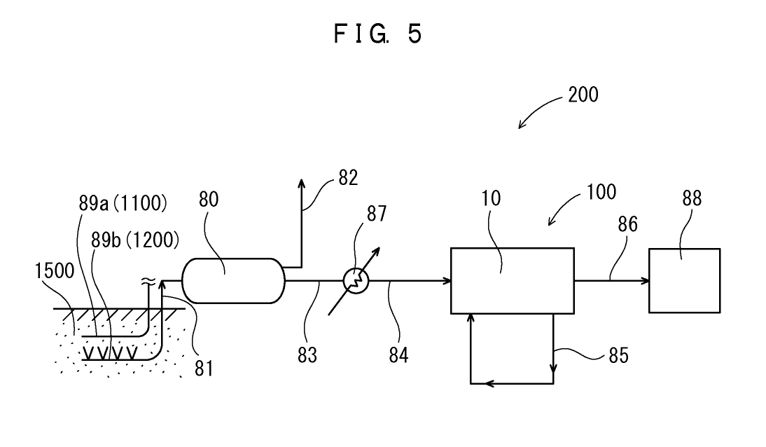

With reference to FIG. 5, an embodiment of the present invention will be described. FIG. 5 shows a bitumen production system 200 including an oil/water separation system 100 according to an embodiment of the present invention. The bitumen production system 200 in this embodiment is a system for producing bitumen from oil sand. In the bitumen production system 200 in this embodiment, water used for causing bitumen to flow out from oil sand can be recycled.

The bitumen production system 200 in this embodiment includes an introduction pipe 89a (1100) through which the steam (1150) is introduced into the oil sand layer 1500 containing the oil sand (2000) and a recovery pipe 89b (1200) through which a bitumen-mixed fluid 81 containing bitumen is recovered from the oil sand layer 1500. The bitumen production system 200 also includes a separation device (separator) 80 that is connected to the recovery pipe 1200 and separates bitumen 82 from the bitumen-mixed fluid 81. The separation device (separator) 80 in this embodiment is an oil separator that separates the bitumen-mixed fluid 81 into three phases of vapor (hydrocarbon, water, a small amount of hydrogen sulfide), the bitumen 82, and produced water (oil-containing water) 83.

The bitumen production system 200 in this embodiment includes a membrane distillation device 100 that performs membrane distillation on oil-containing water 83 (84), obtained as a result of the bitumen 82 being removed from the bitumen-mixed fluid 81, by use of a distillation membrane member 10 formed of a porous membrane. In more detail, the membrane distillation device 100 in this embodiment membrane-distills the oil-containing water 83 by use of a porous membrane to remove oil from the oil-containing water 83, and thus can produce treated water (distilled water). The membrane distillation in this embodiment refers to vaporizing water through a porous membrane (e.g., hydrophobic porous membrane) to realize separation into components (e.g., oil/water separation). Specifically, the membrane distillation in this embodiment is a method of keeping the transmission side in a pressure-reduced state so that the supplied liquid (oil-containing water) is vaporized through the porous membrane.

In the structure of this embodiment, the separation device 80 is connected to the membrane distillation device 100 via a cooling device 87. The cooling device 87 cools the oil-containing water 83 discharged from the separation device 80 down to, for example, a temperature lower than 100° C. (in an example, about 90° C., or a predetermined temperature of 50° C. or higher or 60° C. or higher). Oil-containing water 84 that has passed the cooling device 87 contains about 1000 to 3000 mg/liter of oil (oil component) and is introduced into the membrane distillation device 100.

The membrane distillation device 100 in this embodiment includes a circulation pipe (circulation path) 85 through which the oil-containing water 84 is circulated. The circulation pipe 85 allows the oil-containing water 84 that was not membrane-distilled to be returned to the membrane distillation device 100. Treated water 86 obtained as a result of the membrane distillation performed by the membrane distillation device 100 is transferred to a treated water tank 88. The treated water 86 obtained as a result of the membrane distillation performed by the membrane distillation device 100 has an oil concentration of 10 mg/liter or less. As can be seen, the oil concentration of the oil-containing water 84 can be decreased to 1/100 to 1/300.

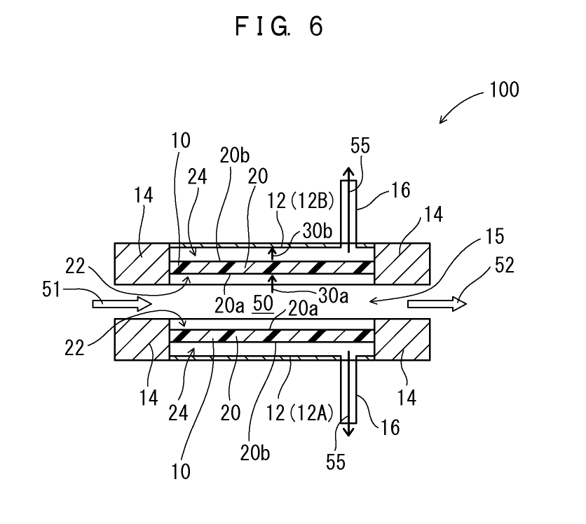

FIG. 6 is a cross-sectional view schematically showing a structure of an example of the membrane distillation device 100 in this embodiment. The membrane distillation device 100 shown in FIG. 6 includes the distillation membrane members 10 each formed of a porous membrane 20. The membrane distillation device 100 includes a housing 12, and the distillation membrane members 10 are accommodated in the housing 12. The housing 12 in this embodiment is formed of a metal material (e.g., stainless steel, etc.), a resin (e.g., polycarbonate, fluorine resin, epoxy resin, etc.; a resin having a heat resistance of 100° C. or higher is preferable), or the like. The distillation membrane members 10 may be formed of only a porous membrane 20, or may each include a plurality of porous membranes 20 arranged in a matrix. The distillation membrane members 10 may have any structure that can perform membrane distillation.

In the structure of this embodiment, the housing 12 includes a bottom housing 12A and a top housing 12B. Both of the housings 12A and 12B each accommodate the distillation membrane member 10 (porous membrane 20). The housing 12 may include one of the bottom housing 12A and the top housing 12B (e.g., the bottom housing 12A). It is not necessary that both of the bottom and top housings each accommodate the distillation membrane member 10. In the case where the housing 12 accommodates one of the distillation membrane members 10, the porous membrane 20 may be provided in one of the housings, for example, the housing 12A, whereas the other housing, namely, the housing 12B, may be formed of a plate-like member (flat plate, etc.). In the case where both of the housings each accommodate the distillation membrane member 10, the area size usable for the membrane distillation per unit area can be twice as large.

In the structure shown in FIG. 6, the planar distillation membrane members 10 are located in the planar housing 12. Each of the planar distillation membrane members 10 does not need to be planar or horizontal in the geometric meaning, and may be curved or may be warped bent due to the weight of the porous membrane 20. Depending on the structure of the distillation membrane member 10, the porous membrane 20 may be bent a plurality of times (e.g., into a sawtooth-like shape or a wavy shape) in order to increase the membrane distillation surface area of the porous membrane 20 usable for the membrane distillation.

The housing 12 is not limited to being planar, and may be tubular (e.g., cylindrical). In this case, the housing 12 shown in FIG. 6 has a cylindrical (or elliptical, oval, rectangular, or polygonal) tube structure, and the bottom housing 12A and the top housing 12B are formed continuously. In this case, the distillation membrane member 10 (porous membrane 20) may be in an annular state and located in the housing 12. For example, both of two ends of one porous membrane 20 may be connected to form a tubular shape. Alternatively, a tubular shape may be formed by curving a porous membrane 20 into a semicircular (or arcked) shape and connecting such porous membranes 20. The porous membranes 20 may be connected in a circumferential direction, or in a length direction (e.g., direction extending from arrow 51 to arrow 52) in order to increase the length thereof.

In the structure of this embodiment, the membrane distillation device 100 includes an oil-containing water flow path (oil-containing water presence area) 15 formed therein. Oil-containing water 51 is introduced into the membrane distillation device 100 from a part thereof (from one end of the oil-containing water flow path 15) and passes the porous membrane 20 inside the membrane distillation device 100 (oil-containing water flow path 15) to be vaporized. Thus, membrane distillation is performed (arrow 30a to arrow 30b). The vaporized steam is transported in a pipe (e.g., pressure reduction pipe) 16 as represented by arrow 55. A part of oil-containing water that did not pass the porous membrane 20 is discharged as oil-containing water 52 from a part of the membrane distillation device 100 (from the other end of the oil-containing water flow path 15).

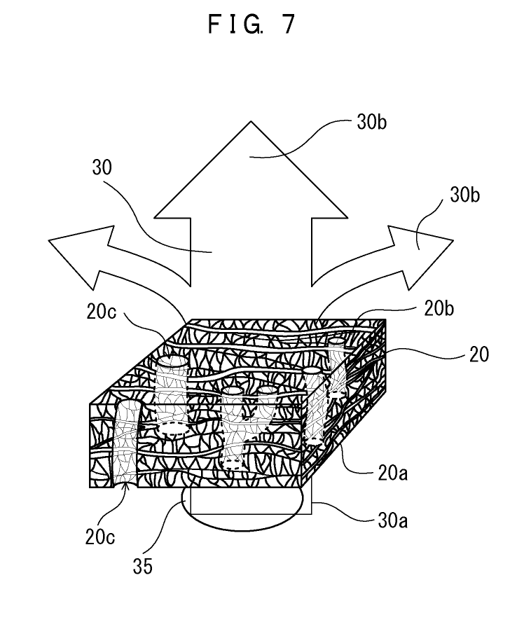

The porous membrane 20 forming the distillation membrane member 10 in the present embodiment is, for example, a porous polytetrafluoroethylene film. FIG. 7 schematically shows a structure of the porous polytetrafluoroethylene film (porous membrane) 20. An example of porous polytetrafluoroethylene film may be Temish (trade name; produced by Nitto Denko Corporation). The porous polytetrafluoroethylene film 20 shown in FIG. 7 has microscopic holes 20c (having a diameter of, for example, 0.1 μm to 10 μm) running from one surface 20a of the film to the other surface 20b of the film. The film (porous membrane) 20 has a function of blocking transmission of a water drop 35 (having a size of, for example, 100 μm to 3000 μm) while passing water steam 30 (having a diameter of, for example, 0.0004 μm) (arrow 30a to arrow 30b).

The membrane distillation device 100 shown in FIG. 6 includes the distillation membrane members 10 each formed of the porous membrane 20 and oil-containing water storage sites 22 each located so as to contact the surface 20a of the corresponding porous membrane 20. In each oil-containing water storage site 22, the oil-containing water 50 may flow along the flow from arrow 51 to arrow 52, and does not need to stop at the oil-containing water storage site 22. In the structure of this embodiment, the porous membrane 20 forming each distillation membrane member 10 is held by a film fixing member 14, and the position of each oil-containing water storage site 22 depends on the position at which the porous membrane 20 is fixed by the film fixing member 14.

The membrane distillation device 100 in this embodiment includes steam discharge sites 24, from each of which steam (water steam) 30b generated as a result of the oil-containing water passing the porous membrane 20 is discharged. In this structural example, each steam discharge site 24 is coupled to the pressure reduction pipe 16, which is connected to a pressure reduction device (not shown). The inner pressure of each steam discharge site 24 is negative (pressure-reduced state). In the structure shown in the figure, the position of each steam discharge site 24 depends on the position at which the porous membrane 20 is fixed by the film fixing member 14. The steam (water steam) vaporized as a result of the oil-containing water passing each porous membrane 20 is transported in the pipe 16 as represented by arrow 55, and then is condensed to become treated water (distilled water).

The porous membrane 20 in the membrane distillation device 100 shown in FIG. 6 may be formed of a porous film other than the above-described porous polytetrafluoroethylene (porous PTFE) film. The porous membrane 20 may be formed of, for example, a fluoride resin film (fluoride resin sheet) such as a PVDF film (polyvinylidene difluoride film) or the like, a PE film (polyethylene film), a PP film (polypropylene film), an acrylonitrile film, a cellulose acetate film, or the like. From the point of view of heat resistance and/or durability, porous polytetrafluoroethylene (porous PTFE) is superior. A material other than porous PTFE may be used in the case where such a material is treated to be heat resistant, subjected to appropriate surface treatment or changed in the material composition, or in the case where the structure of the distillation membrane member 10 is arranged as necessary.

The porous membrane 20 in this embodiment is preferably formed of a hydrophobic material (e.g., polytetrafluoroethylene). A reason for this is that as shown in FIG. 7, in the case where the surface 20a of the porous membrane 20 is hydrophobic, the water drop 35 of the oil-containing water (50) is repelled by the porous membrane 20. As a result, even if the other surface 20b side of the porous membrane 20 is in a pressure-reduced state, the water drop 35 does not pass the porous membrane 20, and the water steam 30 (30a) of the oil-containing water (50) passes the porous membrane 20 selectively (namely, only the water steam passes the porous membrane 20) to be vaporized. Namely, membrane distillation is performed successfully.

In the case where the porous membrane 20 is formed of a material that is not hydrophobic or in the case where the hydrophobicity (water repellency) of the porous membrane 20 is to be improved, a surface of the porous membrane 20 that is to contact the oil-containing water 50 (or both of the two surfaces) may be treated to be hydrophobic (or water-repellent). In this embodiment, even in the case where porous PTFE is used for the porous membrane 20, the surface thereof may be treated to be water-repellent.

In this embodiment, the water (35) of the oil-containing water (50) is not filtrated through the porous membrane 20. Therefore, a porous membrane that is not treated to be hydrophilic is usable. The present invention does not exclude a case where the porous membrane 20 formed of a material that is not hydrophobic is used with necessary arrangements to perform membrane distillation. However, it is not necessary to treat the porous membrane 20 to be hydrophilic, in which case the efficiency or separation capability of the membrane distillation is decreased.

The porous membrane 20 in this embodiment has an average hole diameter of 0.01 μm or greater and 10 μm or less. The average diameter can be found by, for example, a bubble point method (JIS K 3832). As the hole diameter of the porous membrane 20, a preferable value can be chosen appropriately based on the required amount of the water steam or the like to be transmitted through the porous membrane 20. The thickness of the porous membrane 20 is not limited to any specific value, and is, for example, 0.005 mm to 0.5 mm. As the thickness of the porous membrane 20, a preferable value can be chosen appropriately in accordance with the conditions of use. The porous membrane 20 may be formed of one film. Alternatively, a plurality of films of the same type may be stacked, or a plurality of types of films may be stacked. As the size of the porous membrane 20, a preferable value may be chosen appropriately in accordance with the size of the distillation membrane member 10 or the membrane distillation device 100. In an example, the porous membrane 20 may have a relatively small size of 0.1 m to 1 m in length and 0.1 m to 1 m in width (area size: 0.01 to 1 m2) or may have a relatively large size of 1 m to 10 m in length and 1 m to 3 m in width (area size: 1 to 30 m2).

The oil-containing water 84 introduced into the membrane distillation device 100 in this embodiment has a temperature of 50° C. or higher (e.g., 60° C. or higher, typically, about 90° C.) although being cooled by the cooling device 87 shown in FIG. 5 to some extent. As compared with oil-containing water 84 having a low temperature (e.g., 10° C. to 25° C.), the oil-containing water 84 having such a high temperature is more suitable to membrane distillation because the amount of water steam generated is larger. Namely, in the bitumen production system 200 in this embodiment, the warmed oil-containing water (in other words, the oil-containing water having a temperature of room temperature or higher) 84 is membrane-distilled. Therefore, the energy efficiency is high.

As the temperature of the oil-containing water is higher, the membrane distillation efficiency is higher. Therefore, the oil-containing water may be transferred to the membrane distillation device (oil/water separation unit) 100 without being cooled by the cooling device 87. Even if the oil-containing water is cooled, it is preferable that the temperature of the oil-containing water is kept 60° C. or higher in consideration of the distillation efficiency. A higher temperature of the oil-containing water 84 is more preferable for generating water steam. However, for determining the temperature of the oil-containing water 84 at which the oil-containing water 84 is introduced into the membrane distillation device 100, it is desirable to consider the temperature to which the material of the porous membrane 20 is resistant (or the temperature at which the material is decomposed). In the case where the porous membrane 20 is formed of porous PTFE, the temperature of the oil-containing water may be up to 200° C. in order to allow the plant to be operated in a preferable manner.

In the structure shown in FIG. 5, the membrane distillation device 100 includes the circulation pipe 85 through which the oil-containing water 84 is circulated. Therefore, in the example shown in FIG. 6, the discharged part (arrow 52) of the oil-containing water 50 flows in the circulation pipe 85 and can be membrane-distilled again as inflow oil-containing water (arrow 51). A plurality of (at least two or three) membrane distillation devices 100 may be coupled to perform membrane distillation on the oil-containing water 84 (50) in a multi-stage manner without using (or while also using) the circulation pipe 85.

In the structure shown in FIG. 5, the water steam vaporized by the porous membrane 20 in the membrane distillation device 100 is condensed in the membrane distillation device 100 to become treated water (distilled water), or is condensed outside the membrane distillation device 100 to become treated water (distilled water), and stored in the treated water tank 88. The treated water in the treated water tank 88 is combined with other water (plain water or seawater), and used as water for the introduction pipe 89a (1100) through which steam is introduced into the oil sand layer 1500 or used as treated water in a predetermined step performed by the bitumen production system 200 (or oil plant).

In the membrane distillation device 100 (or bitumen production system 200) in this embodiment, the oil-containing water 84 (83) obtained as a result of the bitumen 82 being removed from the bitumen-mixed fluid 81 that is recovered from under the ground (1000) is membrane-distilled by use of the distillation membrane member 10 formed of the porous membrane 20. According to the oil/water separation method which performs filtration by use of a porous membrane, the oil-containing water passes the porous membrane and thus the porous membrane is clogged. As a result, the separation efficiency by filtration is decreased, and the throughput is decreased because a step of washing the porous membrane is required. By contrast, according to the technique of this embodiment, the porous membrane 20 is used for membrane distillation. Therefore, the frequency of clogging can be decreased as compared with the method of using the porous membrane for filtration.

In the membrane distillation device 100 in this embodiment, impurities (sand, etc.) may be present on the surface (20a) of the porous membrane 20. However, the holes of the porous membrane 20 through which the water steam passes is smaller than the particle size of the impurities (sand, etc.). Therefore, the influence of the impurities can be alleviated as compared with the method using filtration. In the example of the membrane distillation device 100 shown in FIG. 6, the oil-containing water 50 flows (from arrow 51 to arrow 52). Therefore, such impurities mostly flow from the upstream side toward the downstream side without staying on the surface (20a) of the porous membrane 20.

With the oil/water separation method using filtration with a porous membrane, the porous membrane formed of PTFE needs to be treated to be hydrophilic in order to guarantee that water passes the porous membrane smoothly. With the technique in this embodiment, the hydrophobicity can be utilized for membrane distillation, and the porous membrane does not need to be treated to be hydrophilic. The treatment for making the PTFE membrane hydrophilic has a possibility of decreasing the heat resistance thereof. The technique in this embodiment can avoid such a problem.

With the gravitational separation method using the specific gravity difference between oil and water as shown in FIG. 4, there are problems that oil/water separation requires many devices and steps and thus is complicated, that the facilities are costly, and that it is difficult to manage the operation of the facilities. By contrast, the technique in this embodiment can decrease the number of necessary devices and also the number of steps, and accordingly, can decrease the facility costs. Facility management merely needs to be performed on the membrane distillation and thus is simplified. The technique in this embodiment can also improve the oil/water separation efficiency as compared with the gravitational separation method. As a result, the amount of oil in the treated water is decreased. Therefore, the undesirable possibility can be avoided that organic scale is deposited in pipes in a heat exchanger or a boiler, and as a result, corrosion fracture is caused by a thermal stress. In addition, the problem can be avoided that in the case where an evaporator is used in a desalination step, scale trouble occurs by organic substances in the evaporator.

The PTFE porous membrane used as the porous membrane 20 in this embodiment can be produced as follows. First, a liquid lubricant is incorporated into PTFE fine powder, and the resultant mixture is formed into a round bar shape or a planar shape by pressing and is rolled. Next, the liquid lubricant is removed, and the resultant substance is rolled. The PTFE porous membrane is obtained in this manner. The liquid lubricant may be an oil-based solvent such as solvent naphtha, white oil or the like, or hydrocarbon oil such as undecane or the like.

In the structure in this embodiment, in order to prevent the porous membrane 20 from being clogged with oil, it is desirable to treat the porous membrane 20 (PTFE porous membrane) to be liquid-repellent. Specifically, a substance having a small surface tension is applied to a resin porous membrane, and dried to be cured. Thus, the membrane becomes liquid-repellent. As a liquid-repellent agent (water-repellent agent) used to treat the membrane to be liquid-repellent, any agent that forms a film having a surface tension lower than the surface tension of the resin porous membrane is usable. Preferable as such a liquid-repellent agent is, for example, a liquid-repellent agent containing a polymer including a perfluoroalkyl group. The liquid-repellent agent can be applied by impregnation, spraying or the like. An example of method for forming a liquid-repellent film containing a polymer including a perfluoroalkyl group will be described. Coating methods of a solution or a dispersion containing a polymer including a perfluoroalkyl group include an air-spray method, an electrostatic spray method, a dip-coat method, a spin-coat method, a roll-coat method (such as a kiss-coat method, a gravure-coat method, etc.), a curtain flow coat method, an impregnation method and the like. The coating methods also include a film formation method by use of an electrodeposition method or a plasma polymerization method. The method is not limited to any specific method as long as a desired film (liquid-repellent layer) can be formed. From the point of view of guaranteeing a sufficient waterproof property, the average hole diameter of the porous membrane 20 is desirably 0.01 μm or greater and 10 μm or less. The porous membrane 20 preferably has a Gurley permeability of 0.1 to 300 sec/100 cm3.

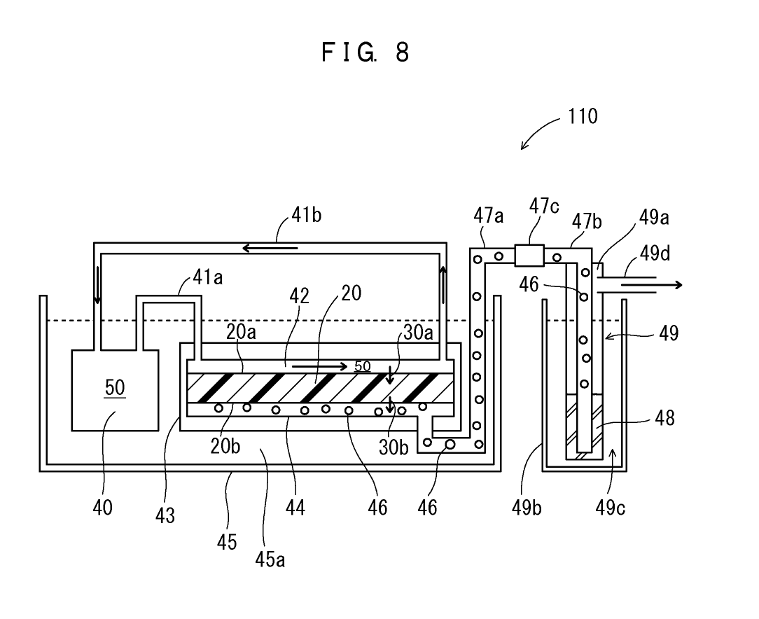

Now, with reference to FIG. 8, examples of the present invention will be described. The examples are provided in order to describe the present invention in detail, and the present invention is not limited to the following examples.

FIG. 8 shows a membrane distillation device 110 on which the present inventors performed an experiment. The membrane distillation device 110 shown in FIG. 8 includes an oil-containing water storage tank 40 that stores the oil-containing water 50 and a housing 43 that accommodates the porous membrane 20. The oil-containing water storage tank 40 is connected to the housing 43 via an introduction pipe 41a through which the oil-containing water 50 is introduced.

The housing 43 and the oil-containing water storage tank 40 are located in a water bath 45. The water bath 45 contains warmed water (water having a temperature of, for example, 50° C. or higher or 60° C. or higher) 45a, so that the temperature inside the housing 43 and the temperature of the oil-containing water 50 in the oil-containing water storage tank 40 are the same. In the housing 43, a reflux pipe 41b through which the oil-containing water 50 is returned to the oil-containing water storage tank 40 is provided. In the path of the reflux pipe 41b, a circulation pump (not shown) through which the oil-containing water 50 is circulated is provided.

In the housing 43, the porous membrane 20 is provided. The oil-containing water 50 flows in an oil-containing water passage site 42 that is on a first surface (herein, top surface) 20a of the porous membrane 20. The oil-containing water 50 flowing in the oil-containing water passage site 42 is membrane-distilled through the porous membrane 20 (arrows 30a, 30b). From a second surface (herein, bottom surface) 20b of the porous membrane 20, steam (water steam) 46 is output. On the second surface 20b side with respect to the porous membrane 20 in the housing 43, a steam accommodation site 44 is located. The steam 46 is collected to the steam accommodation site 44.

The steam accommodation site 44 is connected to a steam transport pipe 47a. The steam 46 is transported in the steam transport pipe 47a. The steam transport pipe 47a is connected to a steam accommodation pipe 47b of a trap device 49 via a connector 47c. The trap device 49 includes a trap member 49a surrounding the steam accommodation pipe 47b and a pressure reduction pipe 49d connected to a part (top part) of the trap member 49a. A tubular member 49b that can hold a cooling medium (e.g., liquid nitrogen) 49c therein is provided around the trap member 49a. The pressure reduction pipe 49d is connected to a pressure reduction device (vacuum pump). The steam 46 collected to the steam accommodation site 44 is transported, by a pressure difference, from the housing 43 via the steam transport pipe 47a and the steam accommodation pipe 47b to the trap device 49. The steam 46 is cooled and condensed by the trap device 49, and is stored as a liquid (distilled water) below the trap member 49a.

The oil-containing water 50 used in the membrane distillation device 110 shown in FIG. 8 was obtained as follows. 1000 mg/liter of C heavy oil produced by Teiseki Topping Plant Kabushiki Kaisha and Emulgen A90 produced by Kao Corporation as a surfactant were added to 5000 mg/liter of ion exchange water, and the resultant substance was stirred for 6 minutes at 2000 rpm by use of Awatori Neritaro ARE-310 produced by Thinky. The resultant substance was used as the oil-containing water 50. In the structural example shown in FIG. 8, the oil-containing water 50 was warmed to a temperature of about 60° C. by use of the water bath 45, and the warmed oil-containing water 50 was circulated for 5 minutes so as to flow on the surface 20a of the porous membrane 20. Then, the pressure was reduced for 15 minutes. In this manner, the oil-containing water 50 was membrane-distilled by use of the porous membrane 20.

As the porous membrane 20 in example 1, a PTFE porous membrane having a membrane area size of about 60 cm2 and a thickness of 0.2 mm that had not been treated to be liquid-repellent was used. As the porous membrane 20 in example 2, a PTFE porous membrane having a membrane area size of about 60 cm2 and a thickness of 0.2 mm that had been treated to be liquid-repellent was used.

Examples 1 and 2 were performed with such porous membranes 20. The amount of the distilled water was 10.0 g in example 1 and 10.7 g in example 2. The resultant distilled water was subjected to liquid-liquid extraction by use of chloroform, and the amount of the organic substances was weighted. The resultant organic substances were subjected to H-NMR measurement to perform component analysis on the organic substances. In both of examples 1 and 2, organic substances of about 10 ppm were obtained. The results of the H-NMR measurement show that the main component of the organic substances was long-chain aliphatic component (also containing chloroform blank-derived component) which was considered to be derived from C heavy oil. Since the long-chain aliphatic component also contained the chloroform blank-derived component, the oil content was concluded as being 10 ppm or less.

As described above, it has been confirmed based on the results obtained from the examples that an oil/water separation method that decreases the content of oil component to 10 ppm or less can be provided by membrane distillation performed by use of the porous membrane 20. The structure and the separation method in the embodiment of the present invention are widely applicable to a method for separating oil and water from each other that are generated by an in-situ recovery method of generating bitumen from oil sand and also to separation of substances other than the oil-containing water generated during the production of bitumen as adopted by the structure shown in FIG. 8. Namely, the structure and the separation in the embodiment of the present invention are usable for treating oil-containing water containing an oil component and water. Specifically, such treatment is realized by membrane-distilling the oil-containing water 50 containing oil component and water by use of the distillation membrane member 10 formed of the porous membrane 20. In more detail, the structure and the separation method in the embodiment of the present invention are usable for treating oil-containing water that is generated during the production of oil, as well as the oil-containing water generated during the production of bitumen. The structure and the separation method in the embodiment of the present invention are also usable for treating industrial oil-containing waste water discharged from plants, oil-containing waste water discharged from food plants, and the like.

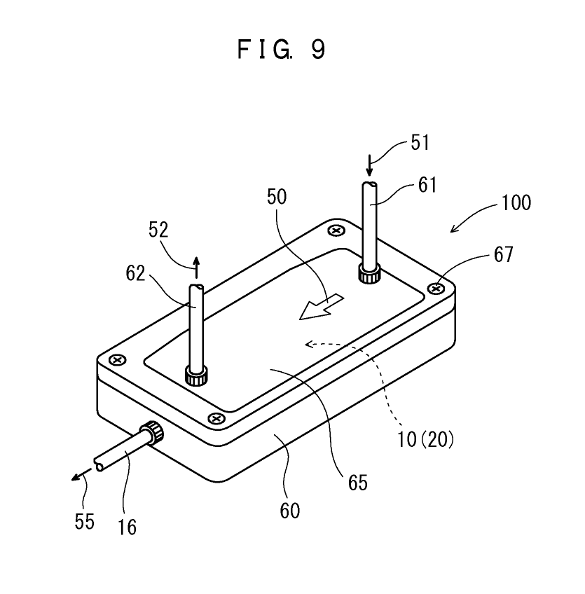

FIG. 9 is a perspective view showing an example of the membrane distillation device 100 in an embodiment according to the present invention. The membrane distillation device 100 shown in FIG. 9 has a planar structure. In a generally parallelepiped housing (casing) 60, the distillation membrane member 10 (porous membrane 20) is set. In the example shown in FIG. 9, a lid member 65 that closes an opening through which the distillation membrane member 10 formed of the porous membrane 20 is introduced is provided on the housing 60. An introduction pipe 61 through which oil-containing water is introduced and a discharge pipe 62 (reflux pipe) through which the oil-containing water is discharged are attached to the lid member 65.

The pressure reduction pipe 16 is attached to a part of the housing 60 (herein, a housing bottom member). A pressure reduction device (not shown) may be connected to the pressure reduction pipe 16 so that one side of the porous membrane 20 located inside the housing 60 is put into a pressure-reduced state. In this manner, the flowing oil-containing water (50) can be membrane-distilled. Steam 55 is discharged from the pressure reduction pipe 16. In the example shown in FIG. 9, top and bottom members of the housing 60 are fixed to each other by tightening members (e.g., screws, etc.) 67. The housing 60 is not limited to having any specific element or tightening member, and may have any structure that can perform membrane distillation.

In the structure shown in FIG. 5, one large device (or two or three devices) may be produced as the membrane distillation device 100 as shown in FIG. 9, so that membrane distillation can be performed in a large area by use of such a membrane distillation device 100. Alternatively, many middle- or small-scaled membrane distillation devices 100 may be coupled to perform membrane distillation. The large membrane distillation device 100 has a membrane distillation area size of, for example, 1 m2 to 30 m2 (or greater). The middle- or small-scaled membrane distillation devices 100 each have a membrane distillation area size of, for example, 0.01 m2 to 1 m2 (or greater). The membrane distillation device 100 shown in FIG. 9 may be modified to have the structure shown in FIG. 6, by which membrane distillation is performed by use of a plurality of (top and bottom) porous membranes 20.

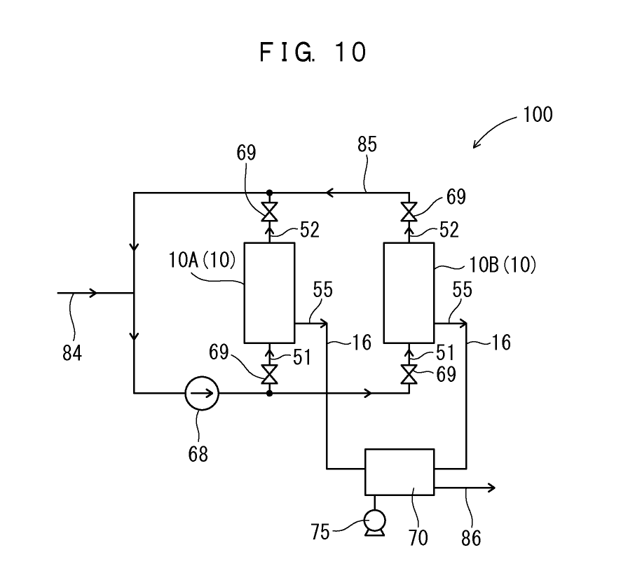

FIG. 10 is a schematic view showing an example of pipework of the membrane distillation device 100 in this embodiment. The membrane distillation device 100 shown in FIG. 10 includes a plurality of distillation membrane members 10 (10A, 10B). The first distillation membrane member 10A and the second distillation membrane member 10B are located parallel to each other. Valves 69 are provided upstream and downstream with respect to each of the first distillation membrane member 10A and the second distillation membrane member 10B. Owing to this structure of the membrane distillation device 100, while membrane distillation is performed by use of either one of the first distillation membrane member 10A and the second distillation membrane member 10B, the other distillation membrane member can be subjected to periodical maintenance, washing, repair, part exchange or the like.

A plant used for the membrane distillation in this embodiment has a lower frequency of clogging than in a plant used for the oil/water separation method using filtration, but is, for example, inspected or repaired as a part of periodical maintenance. Therefore, the structure as shown in FIG. 10, by which while membrane distillation is performed by use of one of the distillation membrane members 10, the other distillation membrane member can stop operating is highly advantageous technologically. In the structure shown in FIG. 10, two distillation membrane members 10 (10A, 10B) are used. Alternatively, three or more distillation membrane members 10 may be located parallel to each other.

In the structure shown in FIG. 10, a circulation pump 68 is provided in a part of the reflux pipe (circulation pipe) 85. The oil-containing water (50) is circulated in the reflux pipe 85 by the pump 68, and is vaporized by membrane distillation performed by use of the distillation membrane member 10 (10A, 10B). The steam 55 from the oil-containing water (50) flows in the pipe 16 to reach a condensation unit 70. A pressure reduction device (pressure reduction pump) 75 is connected to the condensation unit 70. A pressure-reduced state can be provided on one side of each of the distillation membrane members 10 (10A, 10B) by the pressure reduction device 75. As described above, the distillation membrane members 10 are accommodated in the housing that can hold and pass the oil-containing water 50.

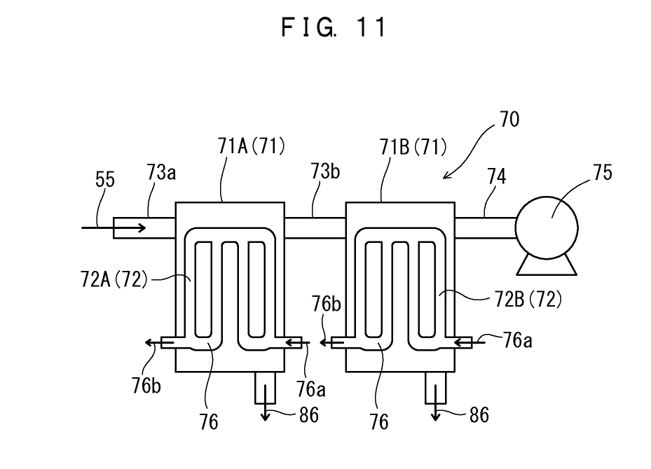

Now, with reference to FIG. 11, an example of the condensation unit 70 in this embodiment will be described. The condensation unit 70 shown in FIG. 11 includes a condenser 71 that condenses the steam (water steam) 55.

The condensation unit 70 in this example includes a plurality of condensers 71 (71A, 71B). The structure in which the plurality of condensers 71 are located in series allows the steam 55, even if not condensed by the condenser 71A, to be condensed by the subsequent condenser 71B. Thus, the condensation efficiency is improved. In FIG. 11, the condensation unit 70 includes two condensers 71 (71A, 71B). Alternatively, the condensation unit 70 may include three or more condensers 71. The condensation unit 70 may include one condenser 71 in the case where it is not necessary to consider decrease in the condensation efficiency, or in the case where the condenser 71 is of high performance.

In the structure shown in FIG. 11, the condensers 71 respectively include cooling pipes 72 (72A, 72B) in which a cooling medium 76 flows. The cooling medium 76 may be cooled water or a coolant (e.g., ammonia, chlorofluorocarbon, halogenated hydrocarbon, isobutane, etc.). The cooling medium 76 may be of any type that can condense steam (water steam). Use of liquid nitrogen as the cooling medium 76 can further improve the efficiency.

The cooling pipes 72 in this embodiment are bent and/or branched in order to have a larger contact area with the steam 55. The cooling pipes 72 may be spiral. The cooling medium 76 supplied from one end of each cooling pipe 72 as represented by arrow 76a is transported in the cooling pipe 72 while cooling (and thus condensing) the steam and is discharged from the other end of the cooling pipe 72 as represented by arrow 76b.

In the structure shown in the figure, the steam 55 introduced into the condenser 71A from a pipe 73a is condensed by the cooling pipe 72A to become distilled water, which is discharged as treated water 86. Since the condenser 71A is coupled to the condenser 71B via a coupling pipe 73b, a part of the steam that is not condensed by the condenser 71A is introduced into the condenser 71B. The steam 55 introduced into the condenser 71B is condensed by the cooling pipe 72B to become distilled water, which is discharged as treated water 86. The obtained treated water 86 is collected and is usable as water for a subsequent step.

The condenser 71B (71) is connected to a pressure reduction pipe 74, which is connected to the pressure reduction device (pump) 75. The pressure reduction device 75 may be, for example, an oil-sealed rotary vacuum pump, a liquid-sealed vacuum pump or the like. The pressure reduction device 75 may be of any type that can realize a pressure-reduced state.

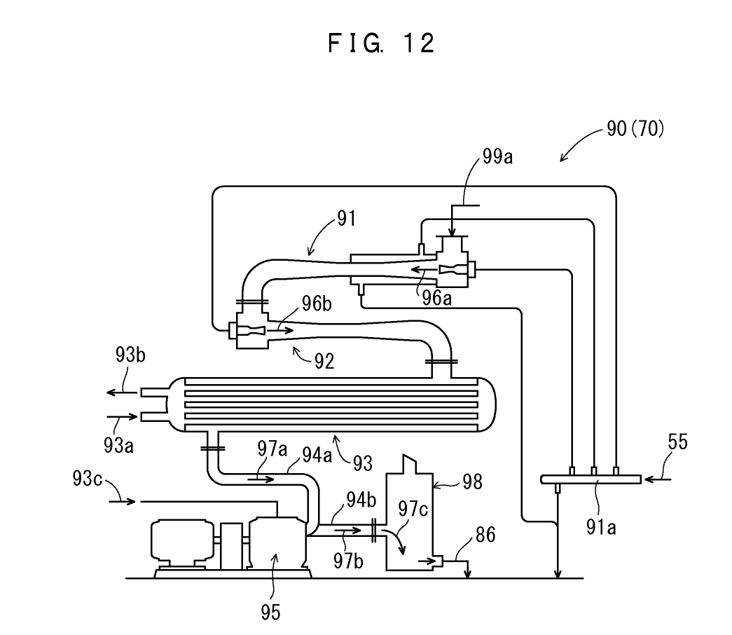

FIG. 12 schematically shows a structure of a condensation unit 90 (70) that includes a water-sealed pump 95. The water-sealed pump 95 is also referred to as a water ring vacuum pump, and can recover water while decreasing the inner pressure of the condensation unit 90 to provide a vacuum state. The condensation unit 90 in this embodiment includes first-through third-stage steam ejectors (91, 92), a surface-type inter-condenser 93 and the water ring (water-sealed) pump 95.

In the condensation unit 90 shown in FIG. 12, the introduced steam (water steam) 55 is transported to a branch pipe 91a, is introduced from the branch pipe 91a to the first-stage steam ejector 91 to become driving gas 96a. Absorbed gas 99a is also introduced into the first-stage steam ejector 91. The steam from the branch pipe 91a is also introduced into the second-stage steam ejector 92 to become driving gas 96b. The ejectors (91, 92) can generate a vacuum state (pressure-reduced state) directly by use of the driving gas (96a, 96b) with no need of a mechanical motion of a pump or the like. The ejectors (91, 92), which have a simple structure with no part of mechanical motion, have higher durability and reliability than a mechanical vacuum pump. Steam ejectors of a structure of three or more stages, or a one-stage steam ejector, may be used instead of the two-stage steam ejectors.

Cooled water 93a is introduced into the inter-condenser 93, and the steam can be indirectly cooled and condensed by the cooled water. Then, the steam is discharged as cooled water 93b. Supplementary water 93c may be introduced into the water ring (water-sealed) pump 95. The water condensed by the inter-condenser 93 is transported to a pipe 94a connected to the inter-condenser 93 as represented by arrow 97a, and then is transported in a pipe 94b as represented by arrow 97b. Then, the water is transported to a noise-muffling separator 98 as represented by arrow 97c, and is discharged as treated water 86. The obtained treated water 86 is collected and is usable as water for a subsequent step.

The condenser unit may have any other structure instead of the structure shown in FIG. 12. For example, the steam (water steam) 55 generated by membrane distillation may be introduced into, and condensed by, the inter-condenser 93, instead of using the steam ejectors (91, 92).

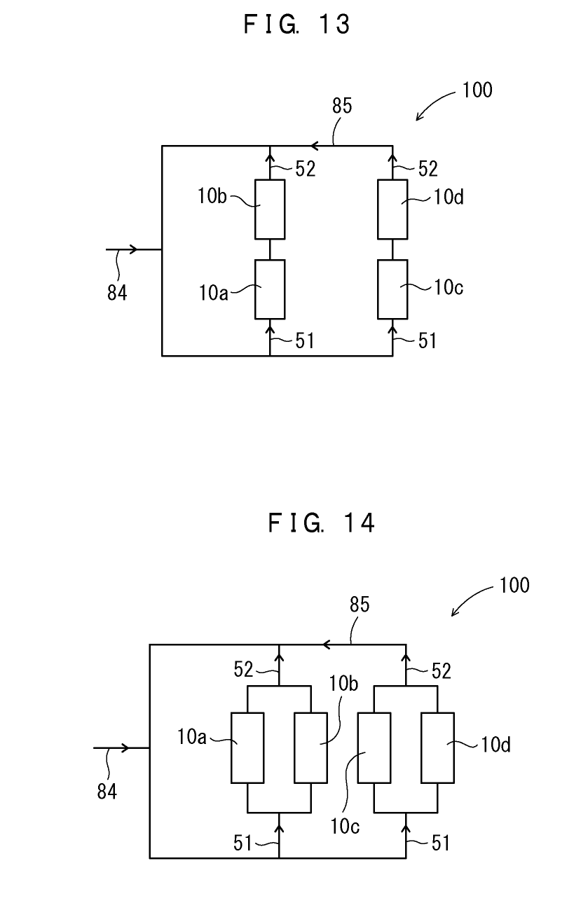

The membrane distillation device 100 in this embodiment may be modified to have a structure shown in FIG. 13 or FIG. 14. In the structure shown in FIG. 10, the distillation membrane members 10A and 10B are located parallel to each other. In the structure shown in FIG. 13, distillation membrane members 10a and 10b are located in series, and distillation membrane members 10c and 10d are located in series. The combination of the distillation membrane members 10a and 10b and the combination of the distillation membrane members 10c and 10d are located parallel to each other. In the structure shown in FIG. 14, the distillation membrane members 10a and 10b are located parallel to each other, and the distillation membrane members 10c and 10d are located parallel to each other. The combination of the distillation membrane members 10a and 10b and the combination of the distillation membrane members 10c and 10d are located parallel to each other. In addition, various other combinations may be realized. The number and the manner of connection of the distillation membrane members 10 may be optional. Upstream and downstream with respect to each distillation membrane member 10, the valves 69 shown in FIG. 10 may be provided. The circulation pump 68 may be located in the reflux pipe (circulation pipe) 85.

In the above embodiments, the structures of the distillation membrane member 10 and the membrane distillation device 100 (50) as shown in FIG. 6, FIG. 8 and FIG. 9 are described. The distillation membrane member 10 and the membrane distillation device 100 are not limited to having such a structure and may be modified in any way as long as membrane distillation can be performed properly. For example, the following modifications may be possible. The porous membrane 20 is folded in half, and a mesh member is held between the folded parts. A plurality of such porous membranes 20 are located in an array to form a distillation membrane member 10. The oil-containing water (50) is caused to flow through the mesh members in the distillation membrane member 10 to be membrane-distilled. Alternatively, the porous membrane 20 and a mesh member which are stacked are wound spirally to form a distillation membrane member 10, and the oil-containing water (50) is caused to flow through the mesh member in the distillation membrane member 10 to be membrane-distilled.

In the membrane distillation device 110 shown in FIG. 8, the water bath 45 is used as a warming device (temperature adjustment device). The warming device may be an oil bath, an electric immersion heater, a mantle heater or the like instead of the water bath 45. Alternatively, a band heater may be wound around the pipe 41a and/or 41b to control the temperature. In the case where the membrane distillation device 100 and the bitumen production system 200 in this embodiment are installed in an area having long hours of sunlight such as on a desert or the like, the oil-containing water 50 may be warmed by use of solar thermal energy or solar energy.

The present invention has been described by way of preferable embodiments. The above description does not limit the present invention, and the present invention may be modified in various manners, needless to say.

### INDUSTRIAL APPLICABILITY

The present invention provides an oil/water separation method capable of decreasing the frequency of clogging, a method for treating oil-containing water, a bitumen production method, and a system therefor.

### DESCRIPTION OF REFERENCE SIGNS

10 Distillation membrane member
12 Housing
14 Film fixing member
15 Flow path
16 Pressure reduction pipe
20 Porous membrane (porous film)
20c Microscopic hole
22 Oil-containing water storage site
24 Steam discharge site
30 Water steam
35 Water drop
40 Oil-containing water storage tank
41a Introduction pipe
41b Reflux pipe
42 Oil-containing water passage site
43 Housing
44 Steam accommodation site
45 Water path
46 Steam
47a Steam transport pipe
47b Steam accommodation pipe
47c Connector
49 Trap device
49a Trap member
49b Tubular member
49d Pressure reduction pipe
50 Oil-containing water
55 Steam
60 Housing
61 Introduction pipe
65 Lid member
68 Circulation pump
69 Valve
70 Condensation unit
71 Condenser
72 Cooling pipe
73b Coupling pipe
74 Pressure reduction pipe
75 Pressure reduction device
76 Cooling medium
80 Separation device
81 Bitumen-mixed fluid
82 Bitumen
83, 84 Oil-containing water
85 Circulation pipe (reflux pipe)
86 Treated water
87 Cooling device
88 Treated water tank
89a Introduction pipe
89b Recovery pipe
90 Condensation unit
91 First-stage steam ejector
91a Branch pipe
92 Second-stage steam ejector
93 Inter-condenser
95 Water-sealed pump
98 Noise-muffling separator
100 Membrane distillation device (oil/water separation system)
110 Membrane distillation device
200 Bitumen production system
1000 Under the ground
1100 Steam introduction pipe
1150 Steam
1200 Recovery pipe
1250 Bitumen-mixed fluid
1500 Oil sand layer
2000 Oil sand
2500 Bitumen

1. An oil/water separation method for separating oil and water from each other that are generated by an in-situ recovery method for producing bitumen from oil sand, the oil/water separation method comprising the steps of:
preparing oil-containing water obtained as a result of the bitumen being removed from a bitumen-mixed fluid recovered from under the ground; and
membrane-distilling the oil-containing water by use of a distillation membrane member formed of a porous membrane.

2. The oil/water separation method according to claim 1, wherein the distillation membrane member is formed of porous polytetrafluoroethylene.

3. The oil/water separation method according to claim 1, wherein the distillation membrane member is formed of a hydrophobic material.

4. The oil/water separation method according to claim 1, wherein the distillation membrane member is formed of a porous membrane that is not treated to be hydrophilic.

5. The oil/water separation method according to claim 1, wherein the distillation membrane member is formed of a porous membrane that is treated to be liquid-repellent.

6. The oil/water separation method according to claim 1, wherein the distillation membrane member is formed of a porous membrane having an average hole diameter of 0.01 μm or greater and 10 μm or less.

7. The oil/water separation method according to claim 1, wherein the oil-containing water to be membrane-distilled has a temperature of 50° C. or higher.

8. The oil/water separation method according to claim 1, wherein the step of membrane-distilling includes the step of cooling steam that is vaporized as a result of the oil-containing water passing the porous membrane and thus making the steam a liquid.

9. The oil/water separation method according to claim 1, wherein in the step of membrane-distilling, the oil-containing water is again circulated and supplied to be membrane-distilled after contacting the distillation membrane member.

10. The oil/water separation method according to claim 1, wherein:
a plurality of the distillation membrane members are provided; and
the oil-containing water is distilled in a multi-stage manner by the plurality of distillation membrane members.

11. The oil/water separation method according to claim 10, wherein:
at least two of the plurality of distillation membrane members are located parallel to each other; and
the oil/water separation method further comprises the step of replacing one of the distillation membrane members located parallel to each other.

12. The oil/water separation method according to claim 1, wherein treated water obtained as a result of the membrane distillation has an oil concentration of 10 mg/liter or less.

13. The oil/water separation method according to claim 1, wherein the in-situ recovery method is an SAGD method or a CSS method.

14. An oil-containing water treatment method for treating oil-containing water containing an oil component and water, the oil-containing water treatment method comprising the step of membrane-distilling the oil-containing water containing the oil component and water by use of a distillation membrane member formed of a porous membrane.

15. The oil-containing water treatment method according to claim 14, wherein:
the distillation membrane member is formed of a porous membrane that is not treated to be hydrophilic; and
in the step of membrane-distilling the oil-containing water, the oil-containing water is again circulated and supplied to be membrane-distilled after contacting the distillation membrane member.

16. The oil-containing water treatment method according to claim 14, wherein the distillation membrane member is formed of porous polytetrafluoroethylene.

17. A bitumen production method for producing bitumen from oil sand, the bitumen production method comprising the steps of:
introducing steam into an oil sand layer containing oil sand;
recovering a bitumen-mixed fluid containing the bitumen from the oil sand layer by the steam;
separating the bitumen from the bitumen-mixed fluid; and
membrane-distilling oil-containing water, obtained as a result of the bitumen being separated from the bitumen-mixed fluid, by use of a distillation membrane member formed of a porous membrane.

18. The bitumen production method according to claim 17, further comprising the step of introducing water generated by the membrane distillation into the oil sand layer.

19. The bitumen production method according to claim 17, wherein the distillation membrane member is formed of porous polytetrafluoroethylene.

20. An oil/water separation system for separating oil and water from each other that are generated by an in-situ recovery method for producing bitumen from oil sand, the oil/water separation system comprising a membrane distillation device for membrane-distilling oil-containing water obtained as a result of the bitumen being removed from a bitumen-mixed fluid recovered from under the ground,
wherein the membrane distillation device includes a distillation membrane member formed of a porous membrane.

21. The oil/water separation system according to claim 20, wherein the membrane distillation device includes:
the distillation membrane member;
an oil-containing water storage site which is in contact with a surface of the porous membrane that forms the distillation membrane member and to which the oil-containing water is supplied; and
a steam discharge site from which steam of water contained in the oil-containing water is discharged as a result of the oil-containing water from the oil-containing water storage site passing the porous membrane;
wherein the steam discharge site is connected to a pressure reduction pipe.

22. The oil/water separation system according to claim 21, wherein:
the oil-containing water flows in the oil-containing water storage site; and
the membrane distillation device is connected to a pipe through which the oil-containing water is circulated.

23. The oil/water separation system according to claim 21, wherein the distillation membrane member is located in a planar state in the membrane distillation device.

24. The oil/water separation system according to claim 21, wherein:
the membrane distillation device has a cylindrical shape; and
the distillation membrane member is located in a cylindrical shape in the membrane distillation device.

25. The oil/water separation system according to claim 21, wherein the distillation membrane member is formed of porous polytetrafluoroethylene.

26. The oil/water separation system according to claim 21, wherein:
a plurality of the distillation membrane members are provided;
at least two of the plurality of distillation membrane members are located parallel to each other; and
one of the plurality of distillation membrane members located parallel to each other is replaceable while membrane distillation is performed by another of the plurality of distillation membrane members located parallel to each other.

27. A system for treating oil-containing water containing an oil component and water, the system comprising a membrane distillation device for membrane-distilling the oil-containing water;
wherein the membrane distillation device includes a distillation membrane member formed of a porous membrane.

28. A system for producing bitumen from oil sand, the system comprising:
an introduction pipe through which steam is introduced into an oil sand layer containing the oil sand;
a recovery pipe through which a bitumen-mixed fluid containing the bitumen is recovered from the oil sand layer by the steam;
a separation device that is connected to the recovery pipe and separates the bitumen from the bitumen-mixed fluid; and
a membrane distillation device for membrane-distilling oil-containing water, obtained as a result of the bitumen being separated from the bitumen-mixed fluid, by use of a distillation membrane member formed of a porous membrane.
